(19) United States
(12) Patent Application Publication
(10) Pub. No.: US 2006/0166156 A1
(43) Pub. Date: Jul. 27, 2006

(54) Wax bath set

(76) Inventor: Amit Pinhasy, Santa Ana, CA (US)

Correspondence Address: CHRISTIE, PARKER & HALE, LLP, PO BOX 7068, PASADENA, CA, 91109-7068, US

(21) Appl. No.: 11/040,901

(22) Filed: Jan. 21, 2005

(51) Int. Cl. F23D 3/16; F21V 35/00

(52) U.S. Cl. 431/289

(57) ABSTRACT

A bath set including a container for storage of bath related items and for use with a floating candle.

### BACKGROUND

This invention relates generally to bath items, and more particularly to bath sets and floating candles.

Personal bathing is a common experience, an experience which is treated as a chore by many. For others, however, bathing is a luxuriant experience, made more enjoyable by employing a variety of aesthetic fragrances and visual queues.

Fragrances, and bath items themselves, may be provided in liquid or solid form. Liquids are often provided in bottles or the like, and solids, such as bath salts may also be so provided. Loose bottles, however, do not necessarily lend themselves for pleasing storage when not in use, and containers for such bottles may be soiled or damaged by excess water on the outer surface of the bottles.

The use of visual bath queues also poses potential problems. For example, floating candles may be viewed by some as enhancing the bath experience. Such candles, however, when in a bathtub may also pose an inconvenience, and the lighting provided by such candles may be less than ideal.

### SUMMARY OF THE INVENTION

The invention provides, in some aspects, a container for a bath set. The invention also provides, in some aspects, a container for a floating candle. In some aspects the invention provides a container for both storage of a bath set and for use with a floating candle.

In some aspects the invention provides a bath set, comprising a container with an open top, the open top being dimensioned so as to receive a floating candle, the container adapted to contain water, internal dimensions of the container sized so as to receive a floating candle therein when water is held by the container; a floating candle at least partially within the container.

In other aspects the invention provides a floating candle apparatus, comprising a container of a largely water impervious material, the container having an open top; a liquid within the container; a floating candle floating on the liquid within the container; wherein the open top of the container has dimensions slightly larger than dimensions of the floating candle.

These and other aspects of the invention are more readily comprehended upon review of the following description and accompanying figures, in which common reference numerals indicate like features throughout.

### BRIEF DESCRIPTION OF THE DRAWINGS

FIG. 1 is a perspective view of the bath set;

FIG. 2 is a front view of the bath set of FIG. 1;

FIG. 3 is a side view of the bath set of FIG. 1;

FIG. 4 is a rear view of the bath set of FIG. 1;

FIG. 5 is a further side view of the bath set of FIG. 1;

FIG. 6 is a top view of the bath set of FIG. 1;

FIG. 7 is a bottom view of the bath set of FIG. 1; and

FIG. 8 illustrates the gift set emptied of its contents, other than a single floating candle

### DETAILED DESCRIPTION OF THE INVENTION

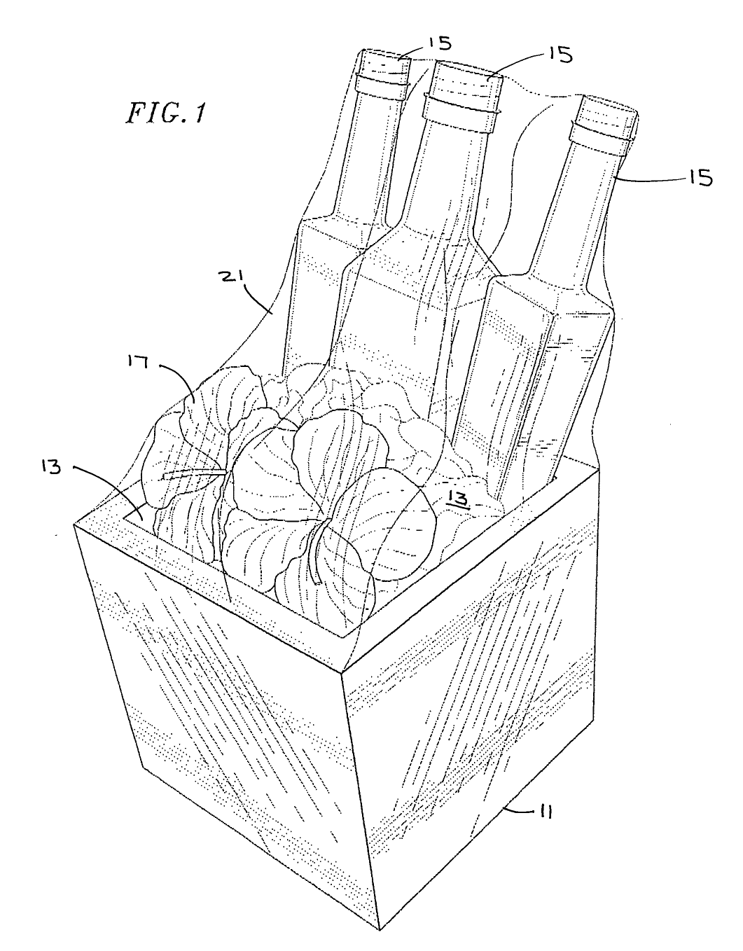

FIG. 1 illustrates a perspective view of a bath set. The bath set includes a container 11. Preferably the container is made of a wax such as a candle wax. As with many candle waxes, the wax may be colored in a variety of patterns and/or shades. For example, in one embodiment the container is an orange candle wax.

Preferably the container is substantially impermeable to water, and has an open top 13. As illustrated, the container is in the shape of a cube with an open top. In other embodiments the container has a variety of shapes, generally shapes forming a container with an open top.

Disposed within the container are a number of bottles 15. Preferably the bottles contain bath items such as bath salts, various bath oils, and soaps and fragrances. As illustrated, the gift set includes three bottles leaning at an angle against a side of the container, with the side being denoted as the rear side of the container.

Floating wax candles 17 are also provided within the container. The floating wax candles are positioned upon a filler 19 provided in the container. The filler, which may be wrapping paper or the like, allows the floating candles to be positioned near the top of the container and preferably facing forward approximate the open top of the container to provide a more pleasing look to the gift set.

Floating candles are relatively well-known, and the floating candles illustrated are in the shape of a flower having petals. The floating candles may be placed on the surface of water, such as in a bathtub, and provide a stunning visual effect when lighted and floating in the bath.

Transparent plastic wrap 21 encases the set, and assists in maintaining position of items in the set. In some embodiments, the container is additionally provided a wrapping bow wound from across the front, side, and rear of the container. The wrapping bow may include a decorative bow, for example, across the front of the container.

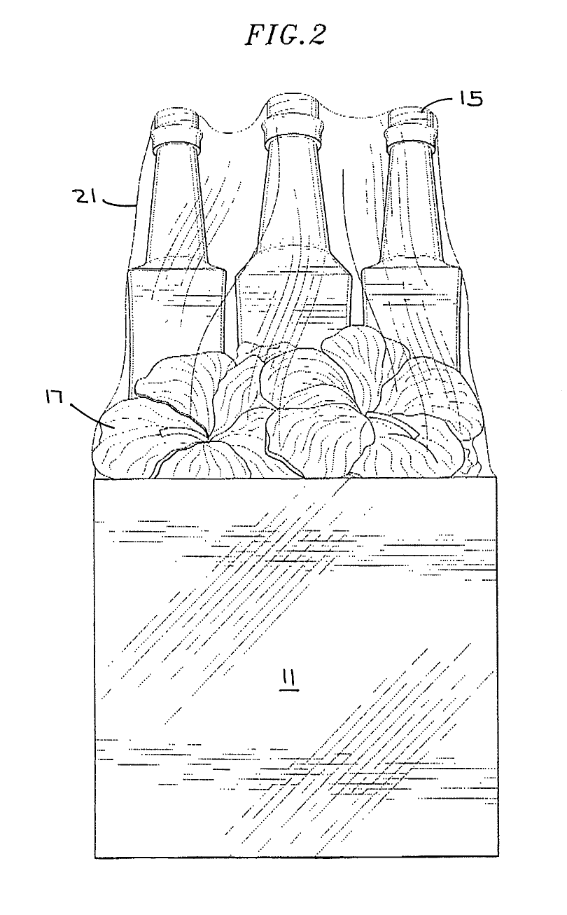

FIG. 2 shows a front view of the gift set. As may be seen in FIG. 2, the bottles extend well beyond the open top of the container. The floating candles are towards the top and front of the container, and, leaning forward, provide a soothing visual effect.

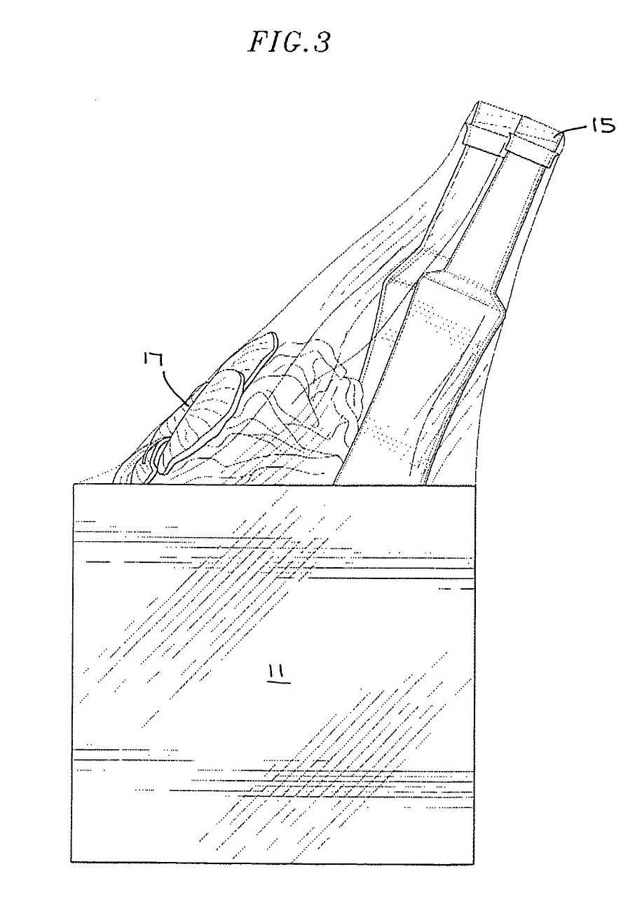

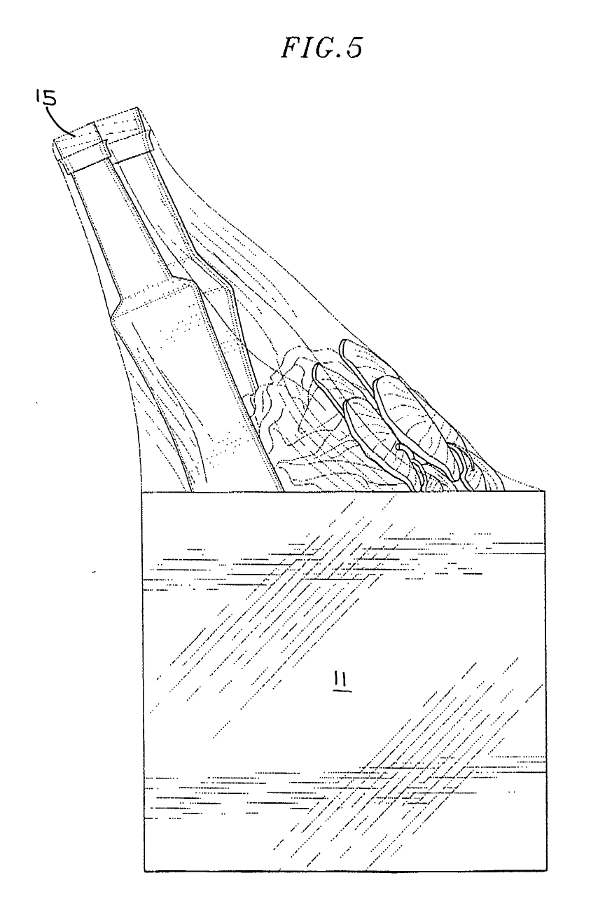

Further details of the gift set may be seen in the side views of the FIGS. 3 and 5. As may be seen in FIGS. 3 and 5, bottles lean rearwardly from within the container, and towards and past the rear edge of the container. Filler, which-may be gift paper or wrapping paper, is crumpled forward of the bottles, and assists in maintaining position of the bottles within the container. On top of the paper, and facing at an angle upwardly forward, are floating candles. A translucent plastic wrap maintains the items in the gift set in their predetermined positions.

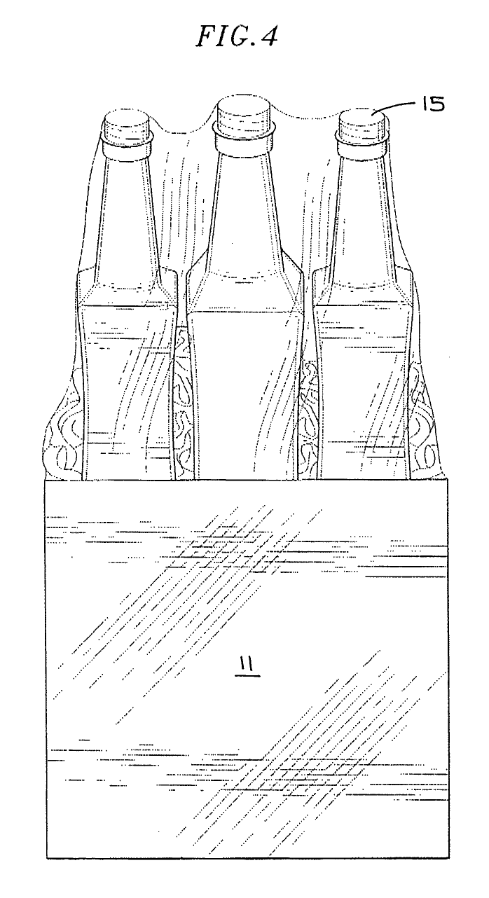

FIG. 4 illustrates a rear view of the gift set, and more fully shows the bottles approximate the rear of the container.

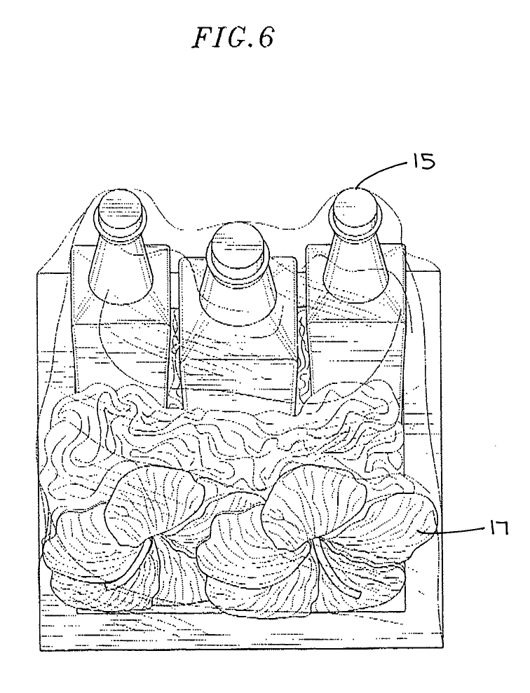

FIG. 6 illustrates a top view of the gift set, and more fully shows the floating candles facing upwardly and forward, and also positioned so as to slightly overlap the edges of the container. From FIG. 6 it can also be seen that the floating candles are sized smaller than the opening of the top of the container.

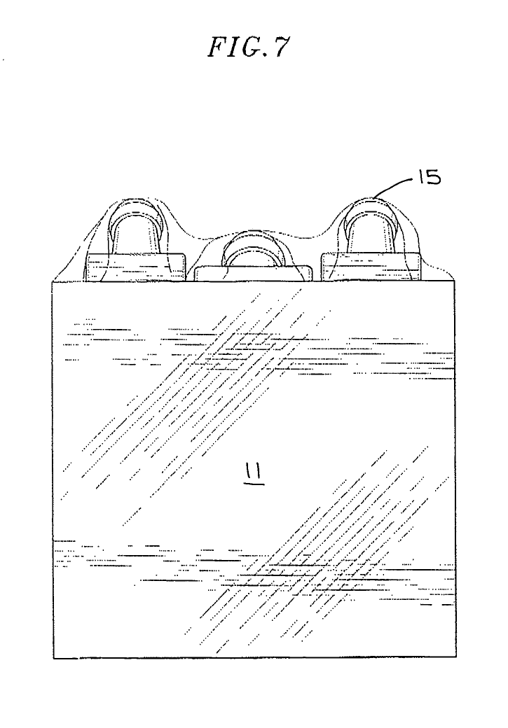

FIG. 7 is a bottom view of the gift set, and is illustrated for completeness. The view of FIG. 7 would not normally be seen by consumers and others as the container would generally be positioned on an opaque surface, or even a translucent surface under which one does not normally crawl.

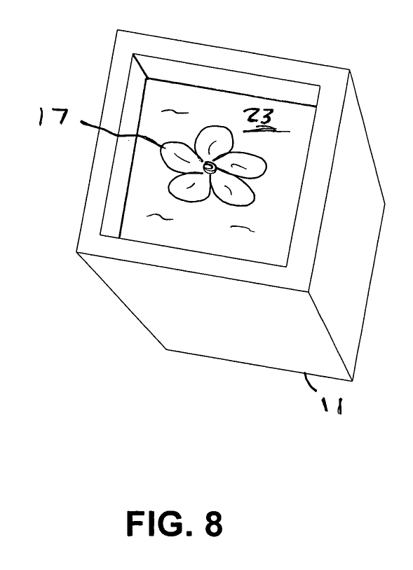

FIG. 8 illustrates the gift set with the container 11 emptied of its contents, other than a single floating candle 17. As previously mentioned, the container is largely impervious to water. This allows the container to be filled with water. As illustrated in FIG. 8, the container is partially filled with water 23. The floating candle is placed on the surface of the water within the container, and when lit, provides a stunning visual effect. The visual effect can be enhanced if the container is only partially full of water, allowing for reflection of the flame within the container.

In some embodiments the wax is semi-transparent, allowing illumination within the container to be transmitted through, at least partially, the walls of the container. A further beneficial aspect of the use of the container to positioning of the floating candle is that the benefits of a floating candle can be obtained without the floating candle interfering with other use of a bath tub, for example.

A bath set is generally described. The bath set has certain visual appealing characteristics, as well as a utility indicated in aspects in the claims below.

What is claimed is:

1. A bath set, comprising:
a container with an open top, the open top being dimensioned so as to receive a floating candle, the container adapted to contain water, internal dimensions of the container sized so as to receive a floating candle therein when water is held by the container;
a floating candle at least partially within the container.

2. The bath set of claim 1 wherein the container is largely impervious to water.

3. The bath set of claim 1 wherein the container comprises wax.

4. The bath set of claim 3 wherein the wax is a semi-translucent wax.

5. The bath set of claim 3 further comprising bottles configured at least partially within the container.

6. The bath set of claim 5 wherein the bottles contain bathing goods.

7. A floating candle apparatus, comprising:
a container of a largely water impervious material, the container having an open top;
a liquid within the container;
a floating candle floating on the liquid within the container;
wherein the open top of the container has dimensions slightly larger than dimensions of the floating candle.

8. The floating candle apparatus of claim 7 wherein the material is wax.

9. The floating candle apparatus of claim 8 wherein the wax is at least partially translucent.

10. The floating candle apparatus of claim 8 wherein the container is configured for storage of bath related bottles.
